(19) United States
(12) Patent Application Publication
(10) Pub. No.: US 2018/0181609 A1
(43) Pub. Date: Jun. 28, 2018

(54) System for De-Duplicating Job Postings

(71) Applicant: Google Inc., Mountain View, CA (US)

(72) Inventors: Chao Chen, Sunnyvale, CA (US); Alonso Alphonsovich Rukubayihunga, San Francisco, CA (US); Christian Posse, Belmont, CA (US); Xuejun Tao, San Jose, CA (US); Ye Tian, Santa Clara, CA (US); Geordon Kitchen, Palo Alto, CA (US)

(21) Appl. No.: 15/391,912

(22) Filed: Dec. 28, 2016

(51) Int. Cl. G06F 17/30; G06Q 10/10

(52) U.S. Cl. CPC G06F 17/30371; G06F 17/30303; G06Q 10/1053; G06F 17/30598; G06F 17/3033

(57) ABSTRACT

Systems and methods for de-duplicating electronic job postings are provided. In one embodiment, a method includes obtaining a first set of data indicative of a job posting. The first set of data includes one or more characteristics associated with the job posting. The method includes accessing a second set of data indicative of a job posting cluster. The job posting cluster includes one or more previous job postings. One of the previous job postings is a master job posting that is representative of the previous job postings. The method includes determining whether the job posting is duplicative of the previous job postings based at least in part on the characteristics associated with the job posting and the master job posting. The method includes providing for storage a third set of data indicative of the job posting associated with the job posting cluster or associated with a new job posting cluster.

### FIELD

The present disclosure relates generally to de-duplicating data for storage and presentation.

### BACKGROUND

Employers often use multiple staffing agencies to fill a job opening. These staffing agencies may edit a job posting creating a multitude of near duplicate instances that may come in the repository of a job aggregator. A company may post a job opening on the career section of its website while using job distributors to further spread the dissemination of the opening across the web. A parent company and its subsidiaries could also be posting the same job on their respective career pages. A job aggregator crawling the company career website and having partnerships with job distributors to get their data feeds may end up with multiple near duplicates of the same job posting. Such duplicate information can decrease available data storage as well as clutter search results and presentation to a user.

### SUMMARY

Aspects and advantages of embodiments of the present disclosure will be set forth in part in the following description, or may be learned from the description, or may be learned through practice of the embodiments.

One example aspect of the present disclosure is directed to a computer-implemented method for de-duplicating electronic job postings. The method includes obtaining, by one or more computing devices, a first set of data indicative of a job posting. The first set of data includes one or more characteristics associated with the job posting. The method includes accessing, by the one or more computing devices, a second set of data indicative of a job posting cluster. The job posting cluster includes one or more previous job postings. One of the previous job postings is a master job posting that is representative of the one or more previous job postings of the job posting cluster. The method includes determining, by the one or more computing devices, whether the job posting is duplicative of the one or more previous job postings based at least in part on the one or more characteristics associated with the job posting and the master job posting. The method includes providing for storage, by the one or more computing devices, a third set of data indicative of the job posting associated with the job posting cluster or associated with a new job posting cluster.

Another example aspect of the present disclosure is directed to a computing system for de-duplicating electronic job postings. The system includes one or more processors and one or more memory devices. The one or more memory devices store instructions that when executed by the one or more processors cause the one or more processors to perform operations. The operations include obtaining a first set of data indicative of a job posting. The first set of data includes one or more characteristics associated with the job posting. The operations include accessing a second set of data indicative of a plurality of job posting clusters. Each job posting cluster includes one or more previous job postings and a master job posting that is representative of the one or more previous job postings of the respective job posting cluster. The operations include identifying one or more candidate job posting clusters of the plurality of job posting clusters based at least in part on the one or more characteristics associated with the job posting. The operations include determining whether the job posting is duplicative of the one or more previous job postings of a first candidate job posting cluster based at least in part on the master job posting of the first candidate job posting cluster.

Yet another example aspect of the present disclosure is directed to one or more tangible, non-transitory computer-readable media storing computer-readable instructions that when executed by one or more processors cause the one or more processors to perform operations. The operations include obtaining a first set of data indicative of a job posting. The first set of data includes one or more characteristics associated with the job posting. The operations include accessing a second set of data indicative of a plurality of job posting clusters. Each job posting cluster includes one or more previous job postings and a master job posting that is representative of the one or more previous job postings of the respective job posting cluster. The operations include identifying one or more candidate job posting clusters of the plurality of job posting clusters based at least in part on the one or more characteristics associated with the job posting. The operations include determining whether the job posting is duplicative of the one or more previous job postings of a first candidate job posting cluster based at least in part on the master job posting of the first candidate job posting cluster. The operations include providing for storage a third set of data indicative of the job posting associated with the first candidate job posting cluster or associated with a new job posting cluster.

Other example aspects of the present disclosure are directed to systems, apparatuses, tangible, non-transitory computer-readable media, user interfaces, memory devices, and electronic devices for de-duplicating data, such as electronic job postings.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example system for de-duplicating electronic job postings according to example embodiments of the present disclosure;

FIG. 2 depicts example job posting clusters according to example embodiments of the present disclosure;

FIG. 3 depicts an example data processing pipeline according to example embodiments of the present disclosure;

FIG. 4 depicts a flow diagram of an example method of de-duplicating electronic job postings according to example embodiments of the present disclosure;

FIG. 5 depicts a flow diagram of an example method of determining whether a job posting is duplicative of the one or more previous job postings according to example embodiments of the present disclosure; and

FIG. 6 depicts system components according to example embodiments of the present disclosure.

### DETAILED DESCRIPTION

Reference now will be made in detail to embodiments, one or more example(s) of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to de-duplicating job postings for improved use of computational storage and processing resources. For instance, employers, staffing agencies, and recruiters are continuously adding new jobs to an existing pool of job postings. A computing system can obtain a job posting from such a third party entity (e.g., submitted via an application programming interface, web-crawled). The job posting can include various characteristics associated with the corresponding job (e.g., title, location, description, salary). For example, the job posting can be associated with a software developer job for Company A in San Francisco, CA. The job can require the ability to design, analyze, and review code, as well as test and debug software. The computing system can process the job posting to determine if it is duplicative of any previous job postings. To do so, the computing system can access a job posting cluster. The job posting cluster can include one or more previous job posting(s). One of the previous job postings of the job posting cluster can be designated as a master job posting that will be used to represent the cluster in comparison to any new job postings. The computing system can determine whether the job posting is duplicative of one or more previous job posting(s) (e.g., of the job posting cluster) based, at least in part, on the one or more characteristic(s) and the master job posting for the cluster. For example, the computing system can process the job title (e.g., software developer job), its location (e.g., San Francisco), its description, etc. to compare the job posting to the master job posting to determine whether the software developer job is duplicative of a posting that has already been published. If it is duplicative, the software developer job posting can be added to the already existing job posting cluster for storage and presentation to a user (e.g., that is searching for job postings). In the event that the job posting is not duplicative, the computing system can create a new job posting cluster for later de-duplication of future job postings. In this way, the systems and methods of the present disclosure can de-duplicate electronic job postings for improved storage, retrieval, and presentation for a user.

More particularly, a computing system can be configured to obtain data indicative of electronic job postings. The computing system can include a web-based server system to which third parties (e.g., employers, recruiters, staffing agencies, or the like) can provide job postings. The computing devices of those third parties can provide data indicative of job postings via an application programming interface (API). In some implementations, the computing system can be configured to crawl webpages (e.g., employer job listing pages, job sites, recruiting sites, social media) to obtain the data indicative of the job postings. Such data can include one or more characteristic(s) associated with the job posting. By way of example, the computing system can obtain data indicative of a job posting associated with a software developer job for Company A in San Francisco, Calif. A description of the job can indicate that the job requires the ability to design, analyze, and review code, as well as test and debug software.

To help determine whether the job posting is duplicative of a previous job posting, the computing system can access data indicative of a plurality of job posting clusters. A job posting cluster can include one or more previous job posting(s). This can include job postings that were previously provided by a third party and/or obtain via web crawling techniques. Each job posting cluster can include a master job posting (e.g., a software engineer job) that is representative of the previous job posting(s) of the job posting cluster. The master job posting can be selected based on a variety of criteria, such as, time, source, and/or other factors. For example, the master job posting can be the first job posting of that cluster obtained by the computing system and/or the job posting obtained via the employer (e.g., Company A). Moreover, only the master job posting need be presented via a user interface to represent the job postings of a cluster, rather than presenting all the duplicative job postings of that cluster. In some implementations, the computing system can select one or more of the job posting cluster(s) as candidates for de-duplication of a newly received job posting based, at least in part, on the master job posting, as will be further described.

The computing system can determine whether the job posting is duplicative of one or more previous job posting(s) of a candidate job posting cluster based, at least in part, on the characteristic(s) associated with the job posting and the master job posting. For example, the computing system can convert at least a portion of the data indicative of the job posting (e.g., title, location) into a plurality of data elements (e.g., shingles each including an n-gram). The computing system can apply a hash function to each of the data elements to create a hash value for each data element (e.g., a hex message digest). The computing system can apply a plurality of permutation rules to each of the hash values to create a plurality of permutations. As will be further described, the computing system can determine a similarity index (e.g., Jaccard similarity coefficient) based, at least in part, on the permutations. The similarity index can be indicative of a similarity between the job posting and the master job posting of the cluster. The computing system can determine that the job posting (e.g., for the software developer job) is duplicative of the master job posting (and, thus, the previous job posting(s) of a job posting cluster) when the similarity index is above a threshold (e.g., Jaccard coefficient>0.9). The threshold can indicate the minimum level of similarity between the master job posting and the job posting that is required for the job posting to be considered duplicative of the master job posting and, thus, the previous job posting(s) of the cluster.

Depending on whether or not it is considered duplicative, the computing system can store the job posting associated with the job posting cluster or a new job posting cluster. For instance, in the event that the software developer job posting for Company A is found to be duplicative of the master job posting (e.g., a software engineer job for Company A), the computing system can store the job posting as posting within the cluster (e.g., assigning the existing cluster identifier to the job posting). In some implementations, the job posting can become the master job posting of the cluster. For example, if the job posting is an updated version of the job posting provided by Company A it may be designated as the master job posting for that cluster. In the event that the job posting is not determined to be duplicative, the computing system can generate a new job posting cluster. The computing system can store the job posting as associated with the new job posting cluster (e.g., assigning the new cluster identifier). Moreover, the job posting (e.g., software developer for Company A) can be designated as the master job posting for the new cluster. In this way, the job posting can be used for de-duplication of future job postings that may be received by the computing system.

Additionally, or alternatively, the computing system can output data indicative of the job posting to a third party. For example, after de-duplication, the computing system can provide data indicative of the job posting (e.g., the software developer posting) associated with the job posting cluster. This can allow the computing system to inform the third party that the job posting is a duplicative of one or more previous job posting(s). Accordingly, the job posting need not be presented via a user interface to a user (e.g., searching for job postings). Rather, only the master job of a job posting cluster need be presented in a user interface for a user.

The system, methods, and apparatuses described herein provide several technical effects and benefits. For instance, the systems and methods allow for job postings to be de-duplicated and stored within a cluster that includes duplicate job postings. This can increase available memory storage by allowing a computing system to archive duplicate job postings, while only needing to readily access the master job posting for that cluster. Moreover, by de-duplicating the job postings, the systems and methods of the present disclosure can reduce the number of postings presented via a user interface to a user (e.g., searching, reviewing job postings). For instance, by de-duplicating a job posting based, at least in part, on a master job posting, the systems and methods can determine whether the master job posting will accurately represent a new job posting. If so, the master job posting can be presented on a user interface to represent that job posting. As such, less search results can be presented to a user, decreasing user interface clutter, and thus, decreasing user interface download time. This can also decrease the amount of user interaction (e.g., mouse clicks, search queries) required for reviewing the job postings. The decrease in search results and user interaction can also reduce the amount of required bandwidth usage and processing resources.

The systems and methods of the present disclosure provide an improvement to computing technology. For instance, the systems and methods improve the ability of a computing system to de-duplicate job postings while decreasing the computational resources required to do so. By way of example, the systems and methods allow a computing system to obtain a first set of data indicative of a job posting (e.g., including characteristic(s) associated with the posting). The computing system accesses a second set of data indicative of a job posting cluster that includes one or more previous job posting(s). One of the previous job posting(s) can be a master job posting that is representative of the previous job posting(s) of the job posting cluster. The systems and methods can allow a computing system to determine whether a job posting is duplicative of the previous job posting(s) based, at least in part, on the job posting (e.g., its one characteristic(s)) and the master job posting. Moreover, the computing system can provide (e.g., for storage, to a third party) a third set of data indicative of the job posting associated with the job posting cluster or associated with a new job posting cluster. By de-duplicating a job posting based, at least in part, on a master job posting, the systems and methods can increase the efficiency with which a job posting is de-duplicated (e.g., rather than comparing to all previous job postings). In this way, the system and methods can improve de-duplication computing technology by increasing processing speeds for faster job posting de-duplication.

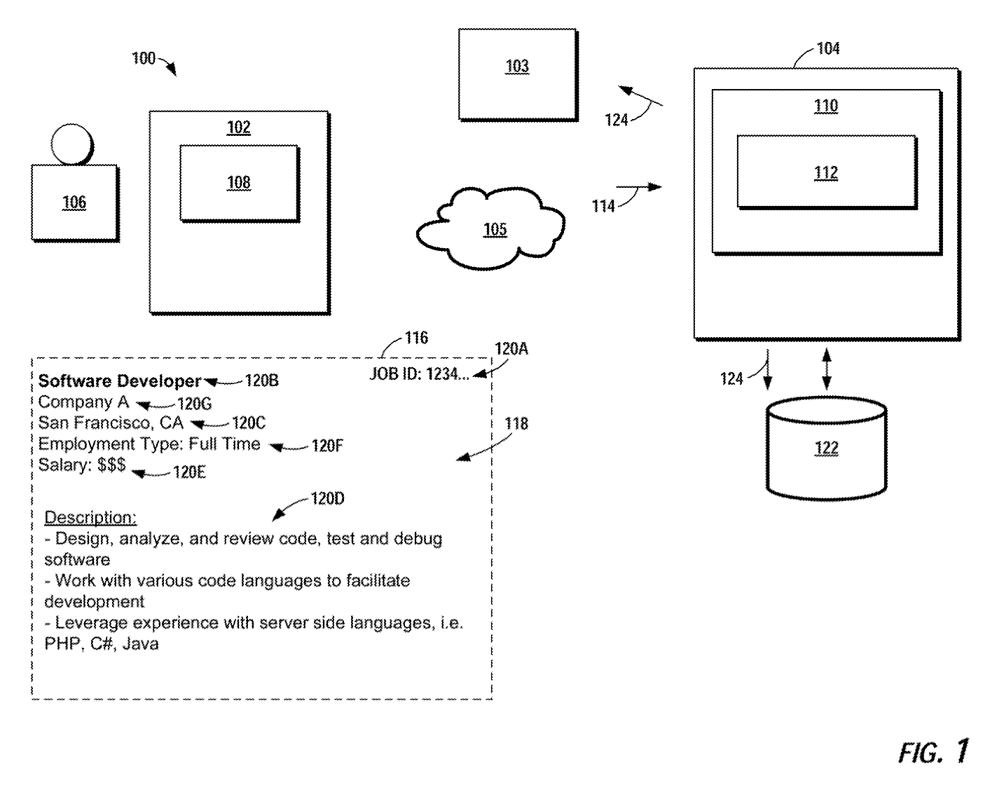

With reference now to the FIGS., example embodiments of the present disclosure will be discussed in further detail. FIG. 1 depicts an example system 100 for de-duplicating electronic job postings according to example embodiments of the present disclosure. The system 100 can include a user computing device 102, a third party computing device 103, and a computing system 104. The user computing device 102, the third party computing device 103, and the computing system 104 can be configured to communicate with one another via one or more wired and/or wireless network(s) 105. The network(s) 105 can include one or more public or private network(s), and can include the Internet. While the following description describes the operations and functions for de-duplicating electronic job postings as being performed by the computing system 104, one or more of the operations and functions could also, or alternatively, be performed by the user computing device 102 and/or third party computing system 103.

The user computing device 102 can be utilized by a user 106. The user computing device 102 can include, for example, a phone, a smart phone, a computerized watch (e.g., a smart watch), computerized eyewear, computerized headwear, other types of wearable computing devices, a tablet, a personal digital assistant (PDA), a laptop computer, a desktop computer, a gaming system, a media player, an e-book reader, a television platform, a navigation system, and/or any other type of mobile and/or non-mobile user computing device. The user computing device 102 can include various components (e.g., including processors, memory devices, etc.) for performing operations and functions, as described herein. The user computing device 102 can also include one or more display device(s) 108 (e.g., display screen) configured to display a user interface. The user interface can be a user interface that allows a user 106 to provide user input such as, for example, a search query, an interface interaction (e.g., mouse click, tap), etc.

The third party computing device 103 can be associated with a third party. The third party can be an entity that generates and/or aggregates job postings. For example, the third party can be an employer, staffing agencies, recruiter, professional website, social media entity, etc. The third party computing device 103 can be configured to provide job postings to the computing system 104. For example, the third party computing system 103 can provide data indicative of job postings via an application programming interface (API) and/or provide data indicative of job postings to an on-boarding system. In some implementations, the third party computing device 103 can place an identifier on the job posting to indicate that the computing system 104 should gather data indicative of the job posting (e.g., via a web crawling technique).

The computing system 104 can be remote from the user computing device 102 and/or the third party computing device 103. For example, in some implementations, the computing system 104 can be a web-based server system. The computing system 104 can include components for performing various operations and functions as described herein. For instance, the computing system 104 can include one or more computing device(s) 110 (e.g., servers). As will be further described herein, the computing device(s) 110 can include one or more processor(s) and one or more memory device(s). The one or more memory device(s) can store instructions that when executed by the one or more processor(s) cause the one or more processor(s) to perform operations and functions for de-duplicating electronic job postings. In some implementations, the computing system 104 can include one or more separate components and/or engines 112, each configured to perform one or more of the operations and functions described herein (e.g., data conversion, hashing, permutation, etc.).

The computing device(s) 110 can be configured to obtain a first set of data 114 indicative of a job posting 116. As indicated herein, the computing device(s) 110 can obtain the first set of data 114 via an application programming interface (API). In some implementations, the computing device(s) 110 can be configured to crawl information (e.g., employer job listing pages, job sites, recruiting sites, social media, web pages) to obtain the first set of data 114 indicative of the job posting 116. In some implementations, the data 114 can be data (e.g., image data) indicative of a hardcopy of a job posting 114 (e.g., captured via an imaging platform). The job posting 116 can be an electronic job posting (e.g., electronic copy, presentable on a computing device, online version, or the like) and can be in various languages (e.g., XML, HTML).

The job posting 116 can include textual content 118 associated with a job (e.g., “Software Developer” for Company A). The textual content 118 can include one or more job characteristic(s) 120A-G associated with a job. The one or more characteristic(s) 120A-G can include a job identifier 120A, a job title 120B, a job location 120C, and a job description 120D, a salary 120E, an employment type 120F, an associated entity 120G, and/or other characteristics. The first set of data 114 can include one or more characteristic(s) 120A-G associated with the job posting 116. In some implementations, such content can be organized within the job posting 116 as separate sections. The computing device(s) 110 can be configured to extract one or more characteristic(s) 120A-G from the job posting 116 using textual recognition techniques (e.g., OCR), a machine-learned model, natural language parser, and/or other extraction techniques.

To help determine whether the job posting 116 is duplicative of any previous job postings, the computing device(s) 110 can be configured to access (or otherwise obtain) a second set of data 122 indicative of a plurality of job posting clusters. As shown in FIG. 1, the second set of data 122 can be stored within one or more database(s) that are accessible by the computing system 104. Each job posting cluster can include one or more previous job posting(s) and at least one master job posting that is representative of the one or more previous job posting(s) of the respective job posting cluster. For example, the job posting(s) of a cluster can include job postings that were previously provided by the third party computing device 103, obtained via web crawling techniques, etc. The master job posting can select from the one or more previous job posting(s) of the cluster (e.g., by the computing device(s) 110). The master job posting can be selected based on a variety of criteria, such as, time, source, and/or other factors. For example, the master job posting can be the first job posting of that cluster obtained by the computing device(s) 110. Additionally, or alternatively, the master job posting for a cluster can include the job posting obtained via the employer (e.g., Company A). This can allow the job cluster to be represented by a master job that has not been altered by an entity other than the employer (e.g., a recruiting agency). Moreover, only the master job posting need be presented via a user interface to represent the job postings of a cluster, rather than presenting all the duplicative job postings of that cluster.

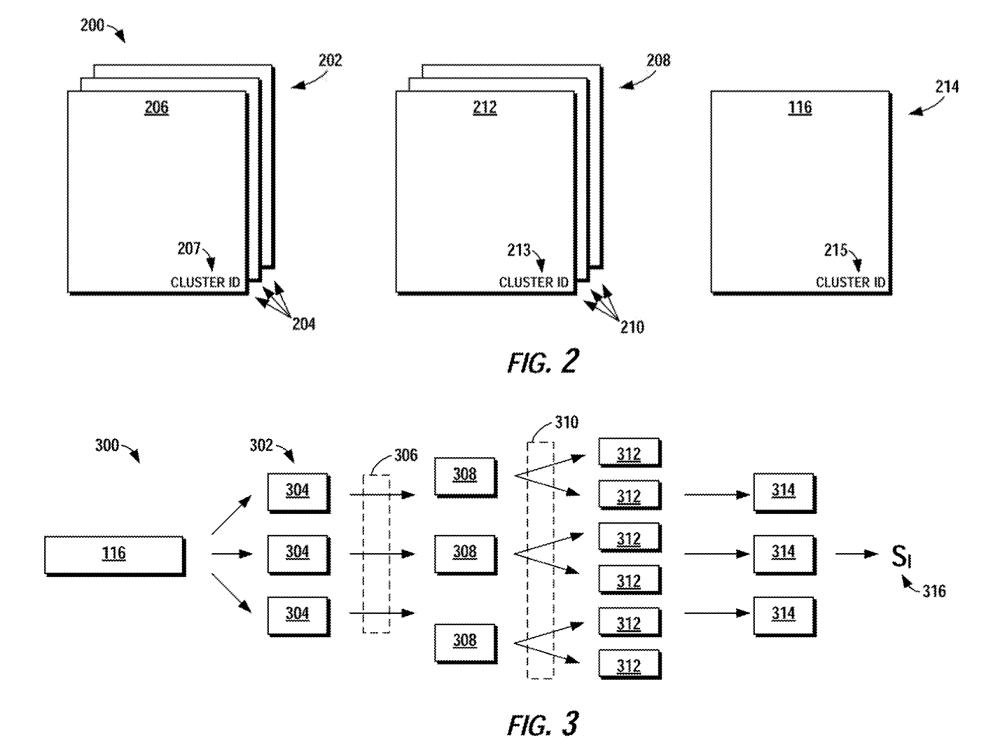

The computing device(s) can be configured to identify one or more candidate job posting clusters of the plurality of job posting clusters based at least in part on the one or more characteristic(s) 120A-G associated with the job posting 116. FIG. 2 depicts example job clusters 200 according to example embodiments of the present disclosure. One or more of the job clusters 200 can be included in the second set of data 122 indicative of a plurality of job posting clusters (e.g., that is accessible by the computing device(s) 110). The job posting clusters 200 can include a first candidate job posting cluster 202 that includes one or more first previous job posting(s) 204. The first candidate job posting cluster 202 can include a first master job posting 206 (e.g., the employer's job posting) that is representative of the one or more first previous job posting(s) 204. The other one or more first previous job posting(s) 204 are duplicative of the first master job posting 206. In some implementations, the first candidate job posting cluster 202 can have a cluster identifier 207 that is assigned and/or otherwise associated with the first candidate job posting cluster 202.

The job clusters 200 can also include a second candidate job posting cluster 208 that includes one or more second previous job posting(s) 210. The second candidate job posting cluster 210 can include a second master job posting 212 that is representative of the one or more second previous job posting(s) 210. The one or more second previous job posting(s) 210 are duplicative of the second master job posting 212. In some implementations, the second candidate job posting cluster 208 can have a cluster identifier 213 that is assigned and/or otherwise associated with the second candidate job posting cluster 208.

The candidate job posting clusters 202, 204 can be identified based, at least in part, on the characteristics associated with the job postings of the respective cluster and the characteristics of the job posting. For example, the first and second candidate job clusters 202, 204 can have the same job title and location as the new job posting 116. Such location information could be, for example, on a city-state level and/or on a street address level. In some implementations, additional information such as salary information, department information, and shift/schedule can also be used to select candidate job clusters. This can be helpful, for example, when all other job information is the same (e.g., a night shift nurse job and a day shift nurse job will not be duplicates).

The computing device(s) 110 can be configured to determine whether the job posting 116 is duplicative of the one or more first previous job posting(s) 204 of the first candidate job posting cluster 202 based at least in part on the first master job posting 206 of the first candidate job posting cluster 202. For example, FIG. 3 depicts an example data processing pipeline 300 according to example embodiments of the present disclosure. The computing device(s) 110 can extract and/or store various types of information associated with a job posting 116 to be used for processing of the job posting 116. For instance, the computing device(s) 110 can extract one or more of the characteristic(s) 120A-G (e.g., job identifier, title, location (e.g., city, state, zip), salary information, job description), shift/schedule information, department/practice information, and/or other information associated with the job posting 116. In some implementations, the computing device(s) 110 can flatten the job posting data to a series of strings (e.g., including text), without punctuation.

The computing device(s) 110 can be configured to convert at least a portion of the first set of data 114 indicative of the job posting 116 from a first format (e.g., as shown in FIG. 1) to a second format 302. For example, the computing device(s) 110 can convert a least a portion of the job posting 116 from a sentence, bullet point, sectionized, etc. format to a second format 302 that includes a plurality of data elements 304. A data element 304 can be, for example, a shingle that includes an n-gram of one or more character(s). In some implementations, a shingle can be a phrase that contains four consecutive tokens. A token can be a term, character, and/or phrase separated by white space (e.g., a space between characters) on each side. The computing device(s) 110 can remove all the punctuations and keep the original case when converting to the second format 302. Moreover, the computing device(s) 110 can avoid the use of stemming. In some implementations, the data elements 304 (e.g., shingles) can be stored in a list-type data structure.

The computing device(s) 110 can be configured to apply one or more hash function(s) 306 to each of the data elements 304 to generate a hash value 308 for each respective data element 304. For example, the computing device(s) 110 can hash the shingles (e.g., strings) into message digests (e.g., numbers). For each shingle, the computing device(s) 110 can convert the tokens to alpha-numeric expressions of fixed language by a hash function 306. A hash function 306 can include, for example, MD5 to ensure that there is no overlap between message digests when there is a large vocabulary involved (e.g., in the job posting).

The computing device(s) 110 can be configured to apply a plurality of permutation rules 310 to each of the hash values 308 to create a plurality of permutations 312. For example, the computing device(s) 110 can permute the generated hash values 308 with a plurality of pre-generated permutation rules. Each rule can be another message digest with the same length in bits as the hash values. For example, if MD5 is used, the rules can be 128-bit long. The permutation method can include exclusive or (XOR) operation. Given a number in [0, N], where N could be a large integer, the result of the XOR operation between this number and a random variable with uniform distribution on [0, N] can also be a random variable with uniform distribution on [0, N]. The XOR operation can be done on a bit level.

With each permutation rule 310, the computing device(s) 110 can generate list of permuted hashes from the original message digests. The computing device(s) 110 can be configured to identify the minimum value 314 of each of the permutations 312 (e.g., permuted hashes). For example, if there are N number of permutation rules 310, there will be N number of minimum hashes, one for each of the permutation rules 310. The collection of minimum values 314 (e.g., minimum of hashes) can represent a fingerprint of the job posting 116.

The computing device(s) 110 can be configured to determine a similarity index 316 based, at least in part, on the plurality of permutations. In some implementations, the similarity index can include a Jaccard similarity coefficient. The similarity index 316 can indicate, for example, the similarity between the job posting 116 and the first master job posting 206 of a first candidate job posting cluster 202. To calculate the similarity index 316, the computing device(s) 110 can compare the permutations 312 (e.g., the minimum values 314) associated with the job posting 116 to permutations associated with the master job posting 206. For example, the computing device(s) 110 can compare the minimum values 314 (e.g., minimum of hashes) to hash values associated with the first master job posting 206. The similarity index 316 can be the ratio of the values that are the same. For example, if there are N number of minimum values 314 and each is the same as a corresponding hash value associated with the master job posting 206, the similarity index 316 is “1”. However, if none of the minimum values 314 are the same, the similarity index 316 is “0”.

The computing device(s) 110 can be configured to determine whether the job posting 116 is duplicative of one or more of the previous job posting(s) 204 of the first candidate job posting 202 based at least in part on the similarity index 316. For example, in the event that the similarity index 316 is equal to or above a threshold value (e.g., 0.9, 0.92, 0.95, 0.99), the computing device(s) 110 can determine that the new job posting 116 is a duplicate of the first master job posting 206, and thus a duplicate of the first candidate job posting cluster 202. In the event that the similarity index 316 is below the threshold value, the computing device(s) 110 can determine that the new job posting 116 is not a duplicate of the first master job posting 206, and thus not a duplicate of the first candidate job posting cluster 202 (e.g., its previous job postings 204). When the job posting 116 is not duplicative of the one or more previous job posting(s) 204 of the first candidate job posting 202, the computing device(s) 110 can be configured to determine whether the job posting 116 is duplicative of the one or more previous job posting(s) 210 of the second candidate job posting cluster 208 based at least in part on a second master job posting 212 of the second candidate job posting cluster 208. The computing device(s) 110 can repeat this process until the job posting 116 has been analyzed against each of the candidate job posting clusters (e.g., the master job posting of each respective candidate).

Returning to FIG. 1, the computing device(s) 110 can be configured to provide a third set of data 124 indicative of the job posting 116 for storage (e.g., in a database 122). In the event that the job posting 116 is determined to be duplicative of the one or more first previous job postings 204 of the first candidate job cluster 202, the job posting 116 can be associated with the first candidate job posting cluster 202. For example, the computing device(s) 110 can assign a cluster identifier 207 to the job posting 116. The cluster identifier 207 can be is associated with the first candidate job posting cluster 202. As such, the job posting 116 can be included in and/or associated with the existing job posting cluster 202 (e.g., for efficient storage).

In some implementations, the job posting 116 can become the master job posting of an existing job posting cluster. For example, the job posting 116 may be a job posting that was obtained from an employer (e.g., Company A) associated with the job (e.g., via an API, web-crawl of the employer's website). The computing device(s) 110 can remove the first master job posting 206 from the first candidate job posting cluster 202. The computing device(s) 110 can designate the job posting 116 as a new master job posting for the first candidate job posting cluster 202. As such, the job posting 116 will be used to de-duplicate future job postings. Moreover, only the job posting 116 (as the master job posting) need be presented on a user interface (e.g., via a display device 108) for a user 106 of a user device 102 searching for job postings.

With reference to FIG. 2, the computing device(s) 110 can also be configured to generate a new job posting cluster based at least in part on the job posting 116. For example, in the event that the job posting 116 is not duplicative of the one or more previous job postings (e.g., 204, 210) of the candidate job posting(s) (e.g., 202, 204), the computing device(s) 110 can generate a new job cluster 214. The computing device(s) 110 can generate a new cluster identifier 215 associated with the new job posting cluster 214. The job posting 116 can be designated as the master job posting of the new job posting cluster 214. In such a case, the computing device(s) 110 can provide for storage a third set of data 124 indicative of the job posting 116 associated with the new job posting cluster 214. Thus, the new job posting cluster 214 can be used for duplication of future job postings.

In some implementations, the computing device(s) 110 can be configured to inform a third party of the duplicative job posting. For example, as shown in FIG. 1, the computing device(s) 110 can be configured to output the third set of data 124 to the computing device 103 associated with the third party. The outputted data 124 can indicate that the job posting 116 is duplicative of a previous job posting. In some implementations, the data 124 can be indicative of the job posting 116 associated with the job posting cluster 202 or associated with the new job posting cluster 214. This can allow a third party 103 (e.g., job posting aggregator) to more efficiently store the job postings that are duplicative of one another, as well as more easily determine which job postings to present to a user 106.

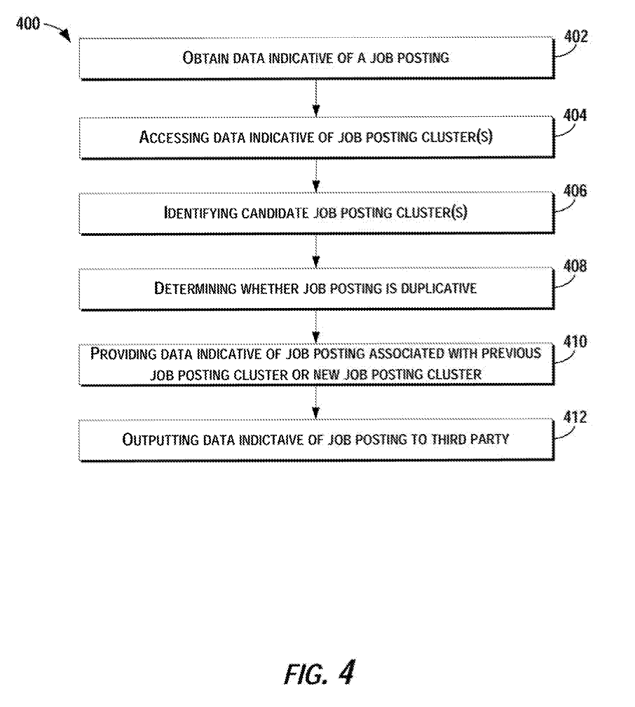

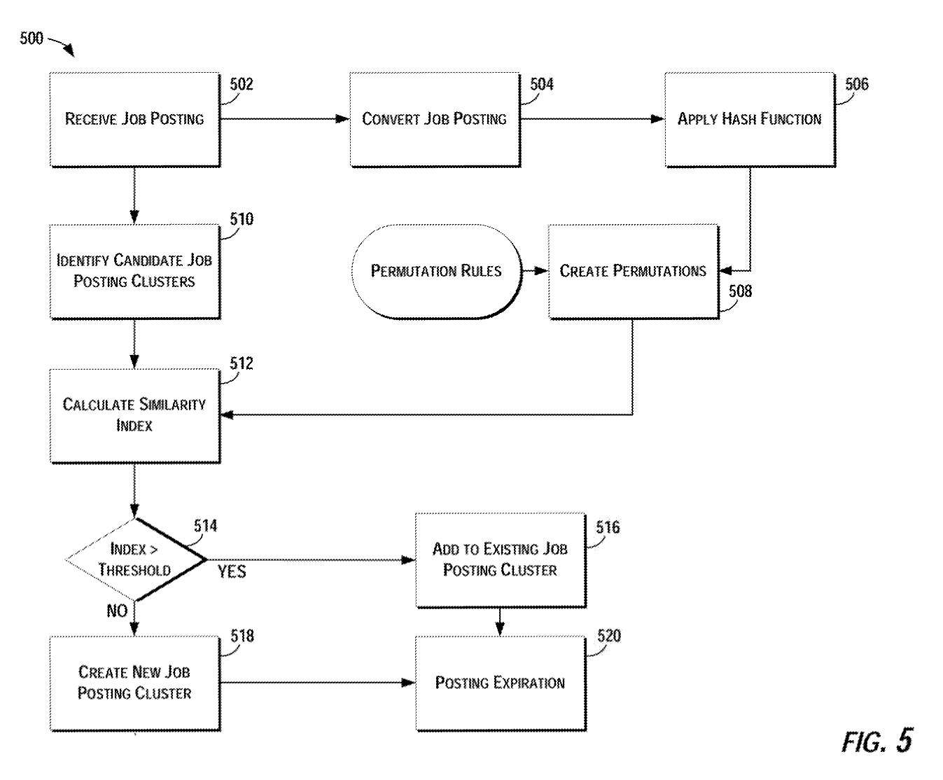

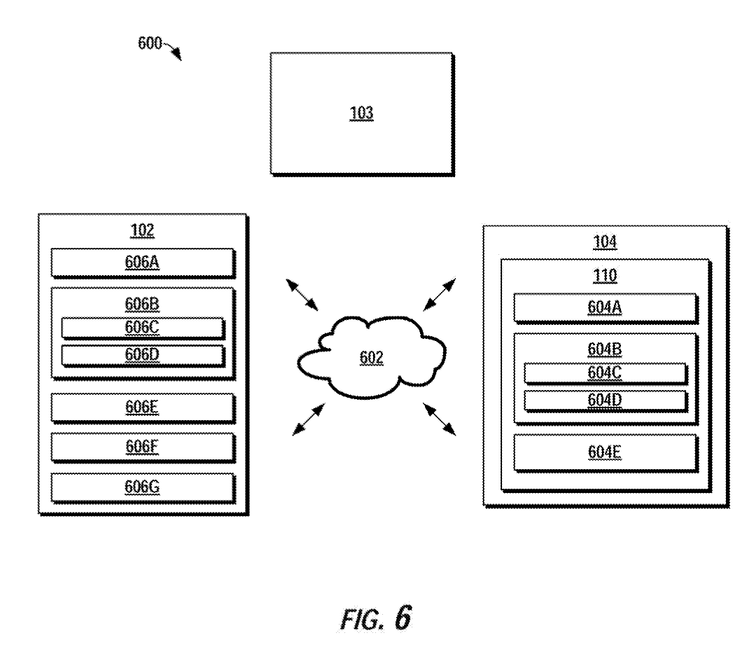

FIG. 4 depicts a flow chart of an example method 400 of de-duplicating electronic job postings according to example embodiments of the present disclosure. One or more portion(s) of method 400 can be implemented via one or more computing device(s) (e.g., 110), such as, for example, those shown in FIGS. 1 and 6. One or more portion(s) of method 400 can be implemented as an algorithm on the hardware (e.g., computer components) of FIGS. 1 and 6 to perform the computer-implemented function(s) as set forth in the claims. FIG. 4 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure.

At (402), the method 400 can include obtaining data indicative of a job posting. For instance, the computing device(s) 110 can obtain a first set of data 114 indicative of a job posting 116. The first set of data 114 includes one or more characteristic(s) 120A-G associated with the job posting 116. For example, the characteristic(s) 120A-G can include at least one of a job identifier 120A (e.g., “JOB ID: 1234”), a job title 120B (e.g., “Software Developer”), a job location 120C (e.g., “San Francisco, Calif.”), and a job description 120D (e.g., “Design, analyze, and review code, test and debug software . . . ”).

At (404), the method 400 can include accessing data indicative of one or more job posting cluster(s). For instance, the computing device(s) 110 can access a second set of data 122 indicative of a job posting cluster (e.g., 202). The job posting cluster 202 can include one or more previous job posting(s) 204. At least one of the previous job posting(s) 204 can be a master job posting 206 that is representative of the one or more previous job posting(s) 204 of the job posting cluster 202. For example, the job posting cluster 202 can include previous job posting(s) for the “Software Developer” job of job posting 116 that have already been provided to and/or obtained by the computing device(s) 110 (and stored accordingly). The master job posting 206 can be a job posting that was previous obtained via the employer (e.g., “Company A”) associated with the “Software Developer” job.

At (406), the method 400 can include identifying candidate job posting cluster(s). For instance, the computing device(s) 110 can identify one or more candidate job posting clusters (e.g., 202, 204) of a plurality of job posting clusters (e.g., 200) based at least in part on the one or more characteristics 120A-G associated with the job posting 116. At (408), the computing device(s) 110 can determine whether the job posting 116 is duplicative of one or more of the previous job postings 204 (e.g., of the candidate job posting cluster 202) based at least in part on the one or more characteristic(s) 120A-G associated with the job posting 116 and the master job posting 206, as further described herein with reference to FIGS. 3 and 5.

At (410), the method 400 can include providing data indicative of the job posting associated with a previous job posting cluster or a new job posting cluster. For instance, the computing device(s) 110 can provide (e.g., for storage) a third set of data 124 indicative of the job posting 116 associated with an existing job posting cluster (e.g., 202) or associated with a new job posting cluster (e.g. 214). The job posting 116 can be associated with the job posting cluster 202 (e.g., via an assigned identifier 207) when the job posting 116 is determined to be duplicative of the one or more previous job posting(s) 204 of the existing job posting cluster 202. The job posting 116 can be associated with the new job posting cluster 214 (e.g., via an assigned identifier 215) when the job posting 116 is not determined to be duplicative of the one or more previous job posting(s) (e.g., of any existing candidate job posting clusters 202, 204).

In some implementations, the method 400 can include outputting data indicative of the job posting to a third party, at (412). For instance, the computing device(s) 110 can output (e.g., to one or more remote computing device(s) 103 that are associated with the third party) a third set of data 124 indicative of the job posting 116 associated with the job posting cluster (e.g., existing cluster 202) or associated with the new job posting cluster 214, as described herein.

FIG. 5 depicts a flow diagram of an example method 500 of determining whether a job posting is duplicative of one or more previous job posting(s) according to example embodiments of the present disclosure. One or more portion(s) of method 500 can be implemented by one or more computing device(s) (e.g., 110), such as, for example, those shown in FIGS. 1 and 6. One or more portion(s) of method 500 can be implemented as an algorithm on the hardware (e.g., computer components) of FIGS. 1 and 6 to perform the computer-implemented function(s) as set forth in the claims. One or more portion(s) of method 500 can be implemented with method 400 (e.g., at 408). FIG. 5 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure.

The computing device(s) 110 can receive a job posting 116, at (502). The computing device(s) 110 can store information (e.g., characteristic(s) 120A-G) associated with the job posting 116 in a data structure. For instance, the computing device(s) 110 can store a job identifier 120A, a job title 120B, a job location 120C (e.g., city, state), a job description 120D, etc.

The computing device(s) 110 can convert at least a portion of the first set of data 114 indicative of the job posting 116 from a first format to a second format 302, at (504). The second format 302 can include a plurality of data elements 304. The computing device(s) 110 can generate the plurality of data elements 304 from the first set of data 114 indicative of the job posting 116, such that each of the data elements 304 includes one or more term(s) from the job posting 116. For example, the second format 302 can include a plurality of data shingles, each shingle comprises an n-gram (e.g., 4-gram). The n-gram can include characters, terms, phrases, etc. of the textual content 118 of the job posting 116 (e.g., the characteristics). The computing device(s) 110 can apply a hash function 306 to each of the data elements 304, at (506). For instance, the computing device(s) 110 can apply a hash function 306 (e.g., MD5) to each of the data shingles to generate a hash value 308 (e.g., a message digest) for each respective data shingle.

The computing device(s) 110 can create a plurality of permutations, at (508). For instance, the computing device(s) 110 can apply a plurality of permutation rules 310 to each of the data elements 304 to create a plurality of permutations 312. For instance, the computing device(s) 110 can apply a plurality of permutation rules 310 to each of the hash values 308 to create the plurality of permutations 312. The plurality of permutation rules 310 can include a set number (“N”) of permutation rules 310. A permutation rule 310 can be a mapping that maps an integer from a range to the same range. The computing device(s) 110 can implement exclusive or (XOR) operation to approximate such mapping. The computing device(s) 110 can use, for example, a pre-generated and stored number of integers. Each integer can serve as the basis for a permutation rule and the mapping can be the XOR operations between the hash value 308 and the integer. For each permutation 312, all shingles can be mapped to new positions. The computing device(s) 110 can identify the smallest permuted hash (e.g., the one with the smallest numerical value). The computing device(s) 110 can store the smallest permuted hash. So for each job posting, after all N permutation rules are finished, there will be a list of N smallest permuted hash values (one for each permutation rule).

At (510), the computing device(s) 110 can identify one or more candidate job posting clusters (e.g., 202, 204) of the plurality of job posting clusters 200 based at least in part on the one or more characteristic(s) 120A-G associated with the job posting 116. The characteristic(s) 120A-G of the new job posting 116 can include multiple binning factors and a job description. The binning factors can be used to identify candidate duplicate clusters. Two job postings can be considered potential duplicates if they have the same values across some or all identified binning factors. Identifying candidate job clusters can include the process of selecting clusters whose master job postings have the same binning factor values with the new job posting 116. For example, the computing device(s) 110 can select a first candidate job posting cluster 202 in the event the job title 120B, location 120C, employment type 120F, salary 120E, etc. associated with the job posting 116 is the same as the job title, location, employment type, salary, etc. of the master job posting 206 of the first candidate job posting cluster 202.

The computing device(s) 110 can determine a similarity index 316 based at least in part on the plurality of permutations, at (512). As indicated herein, the similarity index 316 can indicate the similarity between the job posting 116 and a master job posting (e.g., 206) of a job posting cluster (e.g., 202). By way of example, for all master job postings in the candidate job posting clusters, the computing device(s) 110 can use the N number of smallest permuted hash values to approximate the Jaccard similarity coefficient between the new job posting 116 and the respective master job.

At (514), the computing device(s) 110 can determine whether the job posting 116 is duplicative of the one or more previous job postings 204 of a first candidate job posting cluster 202 based at least in part on the master job posting 206 of the first candidate job posting cluster 202. For instance, the computing device(s) 110 can determine whether the job posting 116 is duplicative of the previous job posting(s) 204 of the first candidate job posting cluster 202 based at least in part on a comparison of the similarity index 316 to a similarity threshold. By way of example, the similar threshold can be 0.9 such that the job posting 116 will be considered to be duplicative if it shares at least ninety percent (90%) of the N number of smallest permuted hashed values in common with a master job posting (e.g., 206).

Additionally, or alternatively, the computing device(s) 110 can calculate the longest common subsequence (LCS) between the job posting 116 and the master job posting (e.g., 206) and the percentage of the longest common subsequence in the respective job descriptions. If the sum of the percentage is over a threshold percentage, the job posting 116 can be considered duplicative of the master job posting (e.g., 206).

In the event that the job posting 116 is duplicative of a master job posting (e.g., 206), the computing device(s) 110 can associate the job posting 116 with the job posting cluster 202, at (516). For example, the job posting 116 (e.g., job identifier 120A) can be added to the job posting cluster (e.g., 202) with which it is duplicative. Additionally, or alternatively, a cluster identifier 207 can be assigned to the job posting 116. In some implementations, the computing device(s) 110 can provide for storage a third set of data 124 indicative of the job posting 116 associated with the job posting cluster 202 when the job posting 116 is determined to be duplicative.

In the event that the job posting 116 is associated with an existing job posting cluster (e.g., 202), the computing device(s) 110 can evaluate the job posting 116 to determine if the job posting 116 should become a master job posting of the job posting cluster based at least in part on the rules for selecting a master job posting (e.g., rules based on source of job posting, timing, or the like). In some implementations, in the event that the job posting 116 is selected as the master job posting, the computing device(s) 110 can remove the previous master job posting (e.g., 206) as the master job posting for the cluster (e.g., the designation, identifier associated therewith). In some implementations, a job posting cluster can include one or more master job posting(s). The computing device(s) 110 can determine whether the job posting 116 should be added to the one or more master job postings (e.g., a list of master job postings for that cluster).

The computing device(s) 110 can determine that the job posting 116 is not duplicative of a previous job posting. For example, in the event that the similar index 316 is less than the similarity threshold (e.g., less than 0.9, has less than 90% smallest permuted hash values in common with a master job posting), the computing device(s) 110 can determine that the job posting 116 is not duplicative of a previous job posting. The computing device(s) 110 can generate a new job posting cluster 214 and associate the job posting 116 with the new job posting cluster 214, at (518). For example, the computing device(s) 110 can generate a new cluster identifier 215 and assign the new cluster identifier to the job posting 116 and/or add the job identifier 120A to the new job posting cluster 214. The job posting 116 can be the master job posting of the new job posting cluster 214 and can be used for future de-duplication.

In some implementations, the computing device(s) 110 can determine whether one or more job posting(s) of a job posting cluster have expired, at (520). For instance, a job posting can be transient and can expire (e.g., when the job is filled, when the associated role/responsibility is no longer needed). The computing device(s) 110 can be configured to determine that a job posting has expired based at least in part on a time and/or date associated with the job posting (e.g., a fill-by date, an apply-by date, expiration date). Additionally, or alternatively, the computing device(s) 110 can be configured to determine that a job posting has expired based at least in part on additional information (e.g., provided by a party associated with the job posting). For example, the computing device(s) 110 can receive data indicating that a particular job posting is no longer valid, has expired, has been filled, is suspended, etc. The computing device(s) 110 can be configured to temporarily or permanently remove a job posting from a job posting cluster (e.g., delete the posting, dis-associate the posting identifier) based at least in part on the determination that the job posting has expired (e.g., based at least in part on the time/date, the additional information). In the event that the job posting that has expired is a master job posting, the computing device(s) 110 can remove the job posting as a master job posting (and/or from the one or more master job postings) of the job posting cluster. The process of determining that a job posting has expired and/or removing a job posting can be performed asynchronously to the process of de-duplicating a job posting, as described herein.

FIG. 6 depicts an example system 600 according to example embodiments of the present disclosure. The system 600 can include one or more user computing device(s) 102, the third party computing device 103, and the computing system 104. The computing system 104, the third party computing device 103, and the user computing device(s) 102 can be configured to communicate via one or more network(s) 602 (e.g., which can correspond to network(s) 105 shown in FIG. 1).

The computing system 104 can include the one or more computing device(s) 110. The computing device(s) 110 can include one or more processor(s) 604A and one or more memory device(s) 604B. The one or more processor(s) 604A can be any suitable processing device (e.g., a processor core, a microprocessor, an ASIC, a FPGA, a controller, a microcontroller, etc.) and can be one processor or a plurality of processors that are operatively connected. The memory device(s) 604B can include one or more non-transitory computer-readable storage media, such as RAM, ROM, EEPROM, EPROM, flash memory devices, magnetic disks, etc., and/or combinations thereof.

The memory device(s) 604B can store information accessible by the one or more processor(s) 604A, including computer-readable instructions 604C that can be executed by the one or more processor(s) 604A. The instructions 604C can be any set of instructions that when executed by the one or more processor(s) 604A, cause the one or more processor(s) 604A to perform operations. In some embodiments, the instructions 604C can be executed by the one or more processor(s) 604A to cause the one or more processor(s) 604A to perform operations, such as any of the operations and functions of the computing device(s) 110 and/or for which the computing device(s) 110 are configured, as described herein, the operations for de-duplicating electronic job postings (e.g., one or more portions of methods 400, 500), and/or any other operations or functions, as described herein. The instructions 604C can be software written in any suitable programming language or can be implemented in hardware. Additionally, and/or alternatively, the instructions 604C can be executed in logically and/or virtually separate threads on processor(s) 604A.

The one or more memory device(s) 604B can also store data 604D that can be retrieved, manipulated, created, or stored by the one or more processor(s) 604A. The data 604D can include, for instance, data indicative of job postings, job posting clusters, cluster identifiers, similarity indexes, extracted information, and/or other data or information described herein. The data 604D can be stored in one or more database(s). The one or more database(s) can be connected to the computing device(s) 110 by a high bandwidth LAN or WAN, or can also be connected to computing device(s) 110 through network(s) 602. The one or more database(s) can be split up so that they are located in multiple locales.

The computing device(s) 110 can also include a communication interface 604E used to communicate with one or more other component(s) of the system 600 (e.g., user computing device(s) 102) over the network(s) 602. The communication interface 604E can include any suitable components for interfacing with one or more network(s), including for example, transmitters, receivers, ports, controllers, antennas, or other suitable components.

The user computing device(s) 102 can be any suitable type of computing device, as described herein. A user computing device 102 can include one or more processor(s) 606A and one or more memory device(s) 606B. The one or more processor(s) 606A can include any suitable processing device, such as a microprocessor, microcontroller, integrated circuit, an application specific integrated circuit (ASIC), a digital signal processor (DSP), a field-programmable gate array (FPGA), logic device, one or more central processing units (CPUs), graphics processing units (GPUs) (e.g., dedicated to efficiently rendering images), processing units performing other specialized calculations, etc. The memory device(s) 606B can include one or more non-transitory computer-readable storage medium(s), such as RAM, ROM, EEPROM, EPROM, flash memory devices, magnetic disks, etc., and/or combinations thereof.

The memory device(s) 606B can include one or more computer-readable media and can store information accessible by the one or more processor(s) 606A, including instructions 606C that can be executed by the one or more processor(s) 606A. For instance, the memory device(s) 606B can store instructions 606C for running one or more software applications, displaying a user interface, receiving user input, processing user input, etc. In some implementations, the instructions 606C can be executed by the one or more processor(s) 606A to cause the one or more processor(s) 606A to perform operations, such as any of the operations and functions of the user computing device(s) 102 and/or for which the user computing device(s) 102 are configured, the operations for de-duplicating electronic job postings (e.g., one or more portions of methods 400, 500), and/or any other operations or functions, as described herein. The instructions 606C can be software written in any suitable programming language or can be implemented in hardware. Additionally, and/or alternatively, the instructions 606C can be executed in logically and/or virtually separate threads on processor(s) 606A.

The one or more memory device(s) 606B can also store data 606D that can be retrieved, manipulated, created, or stored by the one or more processor(s) 606A. The data 606D can include, for instance, data indicative of a user input, data indicative of a user interface and/or other data/information described herein. In some implementations, the data 606D can be received from another device.

The user computing device(s) 102 can also include a communication interface 606E used to communicate with one or more other component(s) of system 600 (e.g., computing device(s) 110) over the network(s) 602. The communication interface 606E can include any suitable components for interfacing with one or more network(s), including for example, transmitters, receivers, ports, controllers, antennas, or other suitable components.

The user computing device(s) 102 can include one or more input component(s) 606F and/or one or more output component(s) 606G. The input component(s) 606F can include, for example, hardware for receiving information from a user, such as a touch screen, touch pad, mouse, data entry keys, speakers, a microphone suitable for voice recognition, etc. The output component(s) 606G can include hardware for audibly producing audio content for a user. For instance, the output component 606G can include one or more speaker(s), earpiece(s), headset(s), handset(s), etc. The output component(s) 606G can include a display device (e.g., 108), which can include hardware for displaying a user interface and/or other information for a user. By way of example, the output component 606G can include a display screen, CRT, LCD, plasma screen, touch screen, TV, projector, and/or other suitable display components.

The network(s) 602 can be any type of communications network, such as a local area network (e.g. intranet), wide area network (e.g. Internet), cellular network, or some combination thereof and can include any number of wired and/or wireless links. The network(s) 602 can also include a direct connection between one or more component(s) of system 600. In general, communication over the network(s) 602 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, computer processes discussed herein can be implemented using a single computing device or multiple computing devices (e.g., servers) working in combination. Databases and applications can be implemented on a single system or distributed across multiple systems. Distributed components can operate sequentially or in parallel.

Furthermore, computing tasks discussed herein as being performed at the computing system (e.g., a server system) can instead be performed at a user computing device. Likewise, computing tasks discussed herein as being performed at the user computing device can instead be performed at the computing system.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method for de-duplicating electronic job postings, comprising:
obtaining, by one or more computing devices, a first set of data indicative of a job posting, wherein the first set of data comprises one or more characteristics associated with the job posting;
accessing, by the one or more computing devices, a second set of data indicative of a job posting cluster, wherein the job posting cluster comprises one or more previous job postings, and wherein one of the previous job postings is a master job posting that is representative of the one or more previous job postings of the job posting cluster;
determining, by the one or more computing devices, whether the job posting is duplicative of the one or more previous job postings based at least in part on the one or more characteristics associated with the job posting and the master job posting; and
providing for storage, by the one or more computing devices, a third set of data indicative of the job posting associated with the job posting cluster or associated with a new job posting cluster.

2. The computer-implemented method of claim 1, wherein the job posting is associated with the job posting cluster when the job posting is determined to be duplicative of one or more of the previous job postings.

3. The computer-implemented method of claim 1, wherein the job posting is associated with the new job posting cluster when the job posting is not determined to be duplicative of one or more of the previous job postings.

4. The computer-implemented method of claim 3, wherein the new job posting cluster comprises a new master job posting, and wherein the job posting is the new master job posting.

5. The computer-implemented method of claim 1, wherein determining, by the one or more computing devices, whether the job posting is duplicative of the one or more previous job postings based at least in part on the one or more characteristics associated with the job posting and the master job posting comprises:
converting, by the one or more computing devices, at least a portion of the first set of data indicative of the job posting from a first format to a second format, wherein the second format comprises a plurality of data elements;
applying, by the one or more computing devices, a plurality of permutation rules to each of the data elements to create a plurality of permutations;
determining, by the one or more computing devices, a similarity index based at least in part on the plurality of permutations, the similarity index indicating a similarity between the job posting and the master job posting of the job posting cluster; and
determining, by the one or more computing devices, whether the job posting is duplicative of the one or more previous job postings based at least in part on a comparison of the similarity index to a similarity threshold.

6. The computer-implemented method of claim 1, wherein converting, by the one or more computing devices, at least the portion of the first set of data indicative of the job posting from the first format to the second format comprises:
generating, by the one or more computing devices, the plurality of data elements from the first set of data indicative of the job posting, wherein each of the data elements comprises one or more terms from the job posting; and
applying, by the one or more computing devices, a hash function to each of the data elements.

7. The computer-implemented method of claim 1, wherein the characteristics comprise at least one of a job identifier, a job title, a job location, and a job description.

8. The computer-implemented method of claim 1, wherein the job posting is associated with a third party, and wherein the method further comprises:
outputting, by the one or more computing devices to one or more remote computing devices that are associated with the third party, the third set of data indicative of the job posting associated with the job posting cluster or associated with the new job posting cluster.

9. A computing system for de-duplicating electronic job postings, comprising:
one or more processors; and
one or more memory devices, the one or more memory devices storing instructions that when executed by the one or more processors cause the one or more processors to perform operations, the operations comprising:
obtaining a first set of data indicative of a job posting, wherein the first set of data comprises one or more characteristics associated with the job posting;
accessing a second set of data indicative of a plurality of job posting clusters, wherein each job posting cluster comprises one or more previous job postings and a master job posting that is representative of the one or more previous job postings of the respective job posting cluster;
identifying one or more candidate job posting clusters of the plurality of job posting clusters based at least in part on the one or more characteristics associated with the job posting; and
determining whether the job posting is duplicative of the one or more previous job postings of a first candidate job posting cluster based at least in part on the master job posting of the first candidate job posting cluster.

10. The computing system of claim 9, wherein the operations further comprise:
providing for storage a third set of data indicative of the job posting associated with the first candidate job posting cluster when the job posting is determined to be duplicative of one or more of the previous job postings.

11. The computing system of claim 10, wherein the operations further comprise:
removing the master job posting from the first candidate job posting cluster; and
designating the job posting as a new master job posting for the first candidate job posting cluster.

12. The computing system of claim 9, wherein the job posting is not duplicative of the one or more previous job postings of the first candidate job posting cluster, the operations further comprising:
determining whether the job posting is duplicative of the one or more previous job postings of a second candidate job posting cluster based at least in part on a second master job posting of the second candidate job posting cluster.

13. The computing system of claim 9, wherein the job posting is not duplicative of the one or more previous job postings of the first candidate job posting, and wherein the operations further comprise:
generating a new job posting cluster based at least in part on the job posting; and
providing for storage a third set of data indicative of the job posting associated with the new job posting cluster.

14. The computing system of claim 9, wherein determining whether the job posting is duplicative of the one or more previous job postings of the first candidate job posting cluster comprises:
converting at least a portion of the first set of data indicative of the job posting from a first format to a second format, wherein the second format comprises a plurality of data elements;
applying a hash function to each of the data elements to generate a hash value for each respective data element;
applying a plurality of permutation rules to each of the hash values to create a plurality of permutations;
determining a similarity index based at least in part on the plurality of permutations, the similarity index indicating a similarity between the job posting and the master job posting of the first candidate job posting cluster; and
determining whether the job posting is duplicative of the one or more previous job postings of the first candidate job posting cluster based at least in part on the similarity index.

15. The computing system of claim 14, wherein the similarity index comprises a Jaccard similarity coefficient.

16. One or more tangible, non-transitory computer-readable media storing computer-readable instructions that when executed by one or more processors cause the one or more processors to perform operations, the operations comprising:
obtaining a first set of data indicative of a job posting, wherein the first set of data comprises one or more characteristics associated with the job posting;
accessing a second set of data indicative of a plurality of job posting clusters, wherein each job posting cluster comprises one or more previous job postings and a master job posting that is representative of the one or more previous job postings of the respective job posting cluster;
identifying one or more candidate job posting clusters of the plurality of job posting clusters based at least in part on the one or more characteristics associated with the job posting;
determining whether the job posting is duplicative of the one or more previous job postings of a first candidate job posting cluster based at least in part on the master job posting of the first candidate job posting cluster; and
providing for storage a third set of data indicative of the job posting associated with the first candidate job posting cluster or associated with a new job posting cluster.

17. The one or more tangible, non-transitory computer-readable media of claim 16, wherein providing for storage the third set of data indicative of the job posting associated with the first candidate job posting cluster comprises:
assigning a cluster identifier to the job posting, wherein the cluster identifier is associated with the first candidate job posting cluster.

18. The one or more tangible, non-transitory computer-readable media of claim 16, wherein providing for storage the third set of data indicative of the job posting associated with the new job posting cluster comprises:
generating a new cluster identifier associated with the new job posting cluster; and
assigning the new cluster identifier to the job posting.

19. The one or more tangible, non-transitory computer-readable media of claim 16, wherein the characteristics comprise a job identifier, a job title, a job location, and a job description.

20. The one or more tangible, non-transitory computer-readable media of claim 19, wherein determining whether the job posting is duplicative of the one or more previous job postings of the first candidate job posting based at least in part on the master job posting of the first candidate job posting comprises:
converting at least a portion of the data indicative of the job posting from a first data format to a second data format, wherein the second format comprises a plurality of data shingles, each shingle comprises an n-gram;
applying a hash function to each of the data shingles to generate a hash value for each respective data shingle;
applying a plurality of permutation rules to each of the hash values to create a plurality of permutations;
determining a similarity index based at least in part on the plurality of permutations, the similarity index indicating a similarity between the job posting and the master job posting of the first candidate job posting cluster; and
determining whether the job posting is duplicative of the one or more previous job postings of the first candidate job posting cluster based at least in part on the similarity index.
